(19) United States
(12) Patent Application Publication
(10) Pub. No.: US 2006/0148424 A1
(43) Pub. Date: Jul. 6, 2006

(54) Wireless transmitter receiver set

(76) Inventor: Wei-Jong Lin, Taipei Hsien (TW)

Correspondence Address: BRUCE H. TROXELL, SUITE 1404, 5205 LEESBURG PIKE, FALLS CHURCH, VA, 22041, US

(21) Appl. No.: 11/113,237

(22) Filed: Apr. 25, 2005

(30) Foreign Application Priority Data
Jan. 5, 2005 (TW) 094200167

(51) Int. Cl. H04B 1/38

(52) U.S. Cl. 455/90.3

(57) ABSTRACT

A wireless transmitter receiver set is disclosed to include a transmitter, which has a signal transmitting module mounted on the inside, a signal firing hole at one end, a connecting portion at the other end, and a control button disposed on the outside for driving the signal transmitting module to transmit a signal out of the signal firing hole, and a receiver, which has a receiving module for receiving signal from the transmitter wirelessly, an electric connector electrically connectable to a computer or computer compatible apparatus, and a connecting portion for fastening to the connecting portion of the transmitter to secure the receiver to the transmitter when not in use.

### BACKGROUND OF THE INVENTION

1. Field of the Invention

The present invention relates to a wireless transmitter receiver set and more particularly, to such a wireless transmitter receiver set, which has the transmitter and receiver detachably fastened together.

2. Description of the Related Art

Following fast development of electronic laser technology, a variety of laser pointers have been developed for pointing things out of a map, blackboard, etc. at a distance.

When a person is addressing a speech, he (she) may have to frequently turn the pages of the prepared document. It is inconvenient to turn the pages when using a laser pointer to point things out of a map, blackboard, etc. In this case, an assistant may be necessary. In order to eliminate this problem, a wireless transmitter receiver set may be used. A wireless transmitter receiver set for this purpose comprises a receiver connectable to, for example, the USB port of a computer, and a transmitter for working as a wireless computer mouse or the like. The user can operate the transmitter to transmit a wireless control signal to the receiver at the computer, thereby causing the computer to execute the command, for example, turning pages. However, it is inconvenient to keep and carry the transmitter receiver set when not in use because the transmitter and the receiver are two separate members.

### SUMMARY OF THE INVENTION

The present invention has been accomplished under the circumstances in view. It is the main object of the present invention to provide a wireless transmitter and receiver set, which has the transmitter and the receiver detachably fastened together for easy carrying when not in use. To achieve this and other objects of the present invention, the wireless transmitter receiver set comprises a transmitter and a receiver detachably connected to the transmitter. The transmitter has a signal transmitting module mounted on the inside, a signal firing hole at one end, a connecting portion at the other end, and a control button disposed on the outside for driving the signal transmitting module to transmit a signal out of the signal firing hole. The receiver has a receiving module for receiving signal from the transmitter wirelessly, an electric connector electrically connectable to a computer or computer compatible apparatus, and a connecting portion for fastening to the connecting portion of the transmitter to secure the receiver to the transmitter when not in use.

### BRIEF DESCRIPTION OF THE DRAWINGS

FIG. 1 is an exploded view of a wireless transmitter receiver set according to the present invention.

FIG. 2 shows the transmitter and receiver of the wireless transmitter receiver set fastened together according to the present invention.

### DETAILED DESCRIPTION OF THE PREFERRED EMBODIMENT

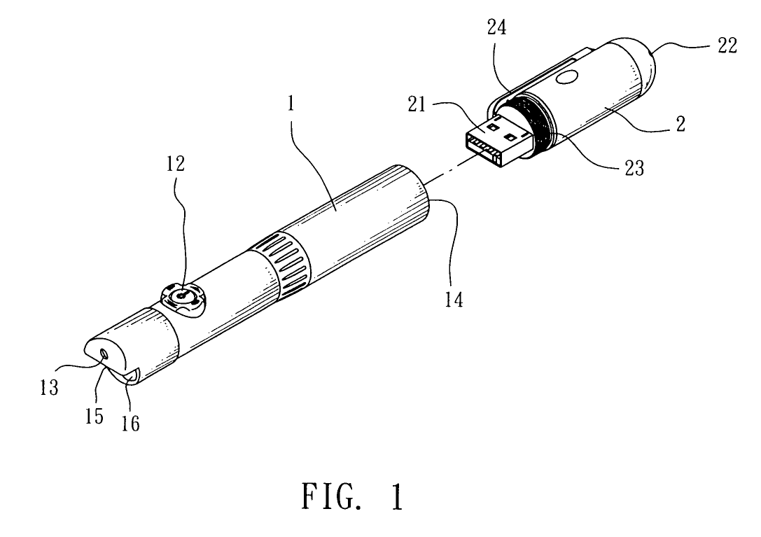

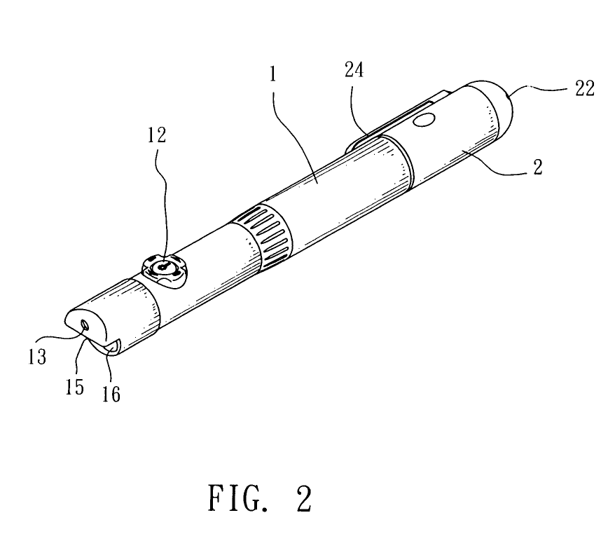

Referring to FIGS. 1 and 2, a wireless transmitter receiver set in accordance with the present invention is shown comprised of a transmitter 1 and a receiver 2.

The transmitter 1 can be made having any of a variety of shapes, for example, cylindrical shape. The transmitter 1 has a signal transmitting module 11 (not shown) mounted on the inside, and a control button (or control buttons) 12 provided on the outside for operating by the user to drive the signal transmitting module 11 to fire a signal out of a signal emitting hole 13 thereof. The control button 12 can be joystick or any of a variety of operating buttons. The transmitter 1 further has a connecting portion 14 at one end for the connection of the receiver 2. The connecting portion 14 can be, for example, an inner or outer thread.

The receiver 2 according to the present preferred embodiment is a cylindrical member, having a receiving module (not shown) mounted on the inside, an electric connector 21, which can be, for example, a USB or 1394 connector electrically connectable to a computer, a signal receiving side 22 for receiving wireless signal from the transmitter 1, a connecting portion 23 connectable to the connecting portion 14 of the transmitter 1, and a clip 24 for fastening. The connecting portion 23 of the receiver 2 can be made connectable to the connecting portion 14 of the transmitter 1 through, for example, a plug joint or screw joint.

When not in use, the transmitter 1 and the receiver 2 are fastened together. When in use, the transmitter 1 and the receiver 2 are set apart by disengaging the connecting portion 14 of the transmitter 1 from the connecting portion 23 of the receiver 2, and then the receiver 2 is connected to a computer or media player. Thus, the user can operate the transmitter 1 to drive the computer or media player to work, for example, to position the cursor on the display screen or to control turning pages.

Further, the transmitter 1 can be incorporated with a laser module (not shown) controllable by the control button 12 to emit a laser beam through a laser firing hole 15. Further, an illuminator module may be installed in the transmitter 1 and controlled to emit light out of a hole 16 at one end of the transmitter 1 for illumination.

A prototype of wireless transmitter receiver set has been constructed with the features of FIGS. 1 and 2. The wireless transmitter receiver set functions smoothly to provide all the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A wireless transmitter receiver set comprising:
a transmitter, said transmitter comprising a signal transmitting module mounted on the inside, a signal firing hole at a first end thereof, a connecting portion at a second end thereof, and at least one control button disposed on the outside thereof for driving said signal transmitting module to transmit a signal out of said signal firing hole; and
a receiver, said receiver comprising a receiving module adapted to receive signal from said transmitter wirelessly, an electric connector electrically connected to said receiving module and electrically connectable to a computer or computer compatible apparatus, and a connecting portion for fastening to the connecting portion of said transmitter to secure said receiver to said transmitter.

2. The wireless transmitter receiver set as claimed in claim 1, wherein said at least one control button is comprised of a plurality of directional control buttons.

3. The wireless transmitter receiver set as claimed in claim 1, wherein the connecting portion of said transmitter and the connecting portion of said receiver are tubular members.

4. The wireless transmitter receiver set as claimed in claim 3, wherein the connecting portion of said transmitter and the connecting portion of said receiver are connectable through a plug joint.

5. The wireless transmitter receiver set as claimed in claim 3, wherein the connecting portion of said transmitter and the connecting portion of said receiver are connectable through a screw joint.

6. The wireless transmitter receiver set as claimed in claim 1, wherein said electric connector of said receiver is a USB connector.

7. The wireless transmitter receiver set as claimed in claim 1, wherein said receiver further comprises a clip for fastening.

8. The wireless transmitter receiver set as claimed in claim 1, wherein said transmitter comprises a laser pointer.

9. The wireless transmitter receiver set as claimed in claim 1, wherein said transmitter further comprises an illuminator.
